(19) United States
(12) Patent Application Publication
(10) Pub. No.: US 2009/0000737 A1
(43) Pub. Date: Jan. 1, 2009

(54) Method for Producing Lightweight Building Panels

(75) Inventors: Erwin Calgua, Edenkoben (DE); Michael Thater, Goldenstedt (DE); Ansgar Schmit, Osnabruck (DE); Bernd Schaper, Diepholz (DE); Erhard Gleinig, Senftenberg (DE); Wolfgang Friedl, Bad Tolz (DE); Hans-Peter Beins, Bad Heilbrunn (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/161,969

(22) PCT Filed: Feb. 7, 2007
(86) PCT No.: PCT/EP07/51157

§ 371 Date: Jul. 24, 2008

(30) Foreign Application Priority Data
Feb. 16, 2006 (DE) 06110019.4

(51) Int. Cl. B32B 37/12; B32B 37/14; B05B 3/10; B65C 11/00

(52) U.S. Cl. 156/331.7; 427/208; 427/207.1; 156/578

(57) ABSTRACT

The invention relates to a method for the production of lightweight building boards comprising at least one outer layer and a core layer adhesively bonded to this, the adhesive being applied to at least one outer layer, wherein the application of the adhesive is effected by means of a rotating disk which is mounted horizontally or with a slight deviation of up to 15° from the horizontal, preferably parallel to the outer layer.

The invention relates to a method for the production of lightweight building boards.

Lightweight building boards are composite elements which consist of two outer layers and at least one core layer arranged between these outer layers and adhesively bonded to them. They are used, for example, in the furniture industry or as lightweight building elements in the building industry.

Such boards have long been known and are described, for example, in German patent no. 670090.

In general, wood boards, in particular particleboards, medium density fiber boards (MDF boards) or boards comprising oriented strands (OSB boards) and plastic boards, metal sheets, in particular those comprising aluminum, or a combination of the boards mentioned are used as outer layers. The thickness of the outer layers used is preferably from 0.5 mm to 20 mm, in particular from 1 mm to 10 mm.

Sheet-like structures having a low weight are used as core layers. These are, for example, honeycomb, folded or plug-type structures comprising paper, board, wood or light metal, in particular aluminum, or lightweight materials, such as light wood-base boards, preferably having a density of from 80 to 400 kg/m³, particularly preferably from 120 to 250 kg/m³ and in particular from 180 to 220 kg/m³.

The lightweight building boards are usually produced by adhesively bonding the outer layers to the core layers discontinuously or in particular continuously. This is preferably effected by providing the outer layers and/or the core layers with an adhesive and then uniting them, the adhesive curing and the components being firmly bonded to one another.

The adhesive is usually applied by means of application heads, as described in EP 1 029 665, rollers, as described in DE 42 37 025, or nozzles, as described in WO 95/28533. A disadvantage of the use of rollers is the tendency to become soiled. In addition, frequently too much adhesive is applied. A disadvantage of the use of nozzle is the danger of aerosol formation. In addition, both methods are limited to the use of one-component adhesives or two-component hotmelt adhesives.

Accordingly, it was intended to find a method by means of which an adhesive is distributed as uniformly as possible over outer layers and/or core layers and which permits continuous production, operates substantially without aerosols and ensures adequate adhesion in spite of a small amount of adhesive. The method should be capable of being used continuously or discontinuously.

It was an object of the present invention to provide a method for the production of lightweight building boards, in which the adhesive can be applied to the outer layer and/or core layer, in which scarcely any aerosols are released, which requires little maintenance, in which all types of adhesives can be used and which permits continuous production and ensures as uniform a distribution as possible of the adhesive in the required amount over the entire width of the lightweight building boards.

The object is surprisingly achieved by applying the adhesive to the outer layer by means of at least one rotating disk present horizontally, preferably parallel to the outer layer.

The invention therefore relates to a method for the production of lightweight building boards comprising at least one outer layer and a core layer adhesively bonded to this, the adhesive being applied to at least one outer layer, wherein the application of the adhesive is effected by means of one or more rotating disk(s) which are arranged one on top of the other and mounted horizontally or with a slight deviation of up to 15° from the horizontal, preferably parallel to the outer layer.

The invention furthermore relates to an apparatus for the production of lightweight building boards by adhesive bonding of at least one outer layer to a core layer, wherein, for the application of the adhesive to the outer layer, said apparatus comprises one or more rotating disk(s) which are arranged one on top of the other and mounted horizontally or with a slight deviation of up to 150 from the horizontal, preferably parallel to the outer layer.

The adhesive is applied by means of the disk which is mounted horizontally, preferably parallel to the lower outer layer, and can be caused to rotate by means of a drive. The disk can also be mounted with a deviation of up to 15° from the horizontal. The disk may be round or elliptical. In the case of a circular disk, an accumulation of adhesive is to be observed in the edge zones of the outer layer in comparison with the center of the outer layer. A slightly elliptical shape of the disk is therefore preferred for minimizing the accumulation of adhesive in the edge zones of the outer layer. Preferably, the disk has a length/width ratio of from 1 to 1.8, particularly preferably from 1 to 1.4 and in particular from 1.0 to 1.25.

In the case of disks arranged one on top of the other, the adhesive is preferably applied to the uppermost disk. Feeding of adhesive to the lower disks is effected through holes in the disk present on top. The number of holes is 4-12, preferably 4-8, particularly preferably 4, of 100-900 mm², preferably 100-650 mm², particularly preferably 100-400 mm², each. Preferably from 2 to 4, particularly preferably 2, disks one on top of the other are used.

The disk may be completely flat or may be rounded or beveled on the side facing upward. The height of the rounded or beveled edge is preferably 1.0-30 mm. A disk rounded or beveled on the sides facing upward is preferred. Holes or slots may be introduced into the bevel for ensuring the discharge of the adhesive. Diameter and number of holes or slots are tailored to one another so that finely distributed application of the adhesive as uniformly as possible over the outer layer present underneath is possible, all material applied to the disk can be discharged, and the maintenance work for the disk is minimal. Preferably, the bevel has 4-64 holes or slots having a diameter or a width of 0.5-5 mm, preferably 16-50 mm, or slots having a diameter or a width of 1-4 mm, particularly preferably 20-40 holes or slots having a diameter or a width of 2-4 mm. The slots are preferably open at the top.

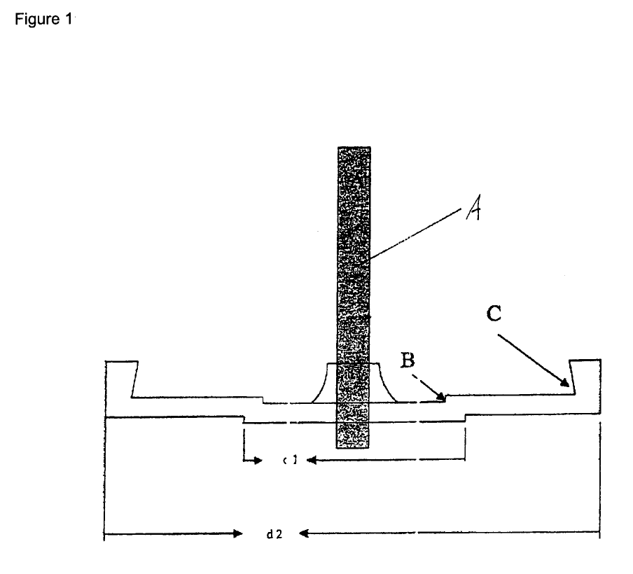

In one embodiment, the disk is in the form of a cascade. FIG. 1 shows the side view of such a disk. The cascades are arranged ascending outward from the axis (A) of rotation. Holes may be provided in the disk at the transitions from one cascade to the adjacent one (B) so that some of the adhesive can be discharged at these cascade transitions onto the lower outer layer. Such a disk in the form of a cascade ensures a particularly uniform application of the adhesive onto the outer layer present underneath. The application of the adhesive to the disk is effected as close as possible to the axis of rotation. Surprisingly, it was found that the adhesive is particularly uniformly distributed over the lower outer layer if the application point of the adhesive is parallel to the production direction exactly before or behind the axis of rotation. A disk having 2-4, preferably 2-3, particularly preferably 2, cascades can be used.

The angle of inclination of the holes or slots which are introduced into the disk for application of the adhesive is about 0-70°, preferably 10-70°, particularly preferably 30-60°, relative to the lower outer layer. The holes may be provided at the cascade transitions and at the outer bevel. The number of holes increases from cascade to cascade from the inside outward. 4-30, preferably 12-25, particularly preferably 12-20, holes having a diameter of 1.0-5.0 mm are provided at the innermost cascade transition (B) relative to the axis of rotation. At the outermost bevel (C), the number of holes or slots is from 4 to 64, preferably 16-50, particularly preferably 20-40, having a diameter of 1.0-5.0 mm. In a particularly preferred embodiment of the disk, the holes or slots at the outer bevel are formed alternately with different inclinations to the outer layer. The ratio of the diameters of adjacent cascades dₙ/dₙ₋₁ is 1.2-4.5, preferably 2-4. The holes may have different angles and diameters in the different cascades. In general, the diameters of the holes decrease toward the edge of the disk.

Depending on the width of the outer layer, the disk has a diameter of from 0.05 to 0.4 m, preferably from 0.1 to 0.30 m, particularly preferably from 0.12 to 0.25 m, based on the long side of the oval shape in the case of oval disks. It is mounted at a height of 0.02-0.2 m, preferably 0.03-0.18 m, particularly preferably 0.03-0.15 m, above the outer layer to be wetted.

The rotating disk may also have the form of a planar, at least four-pointed, preferably four- or five-pointed, star which has rounded points in plan view and no straight lines, and whose points may be curved upward, or, as described, of a planar round disk having borders ascending outward in a cascade-like manner on the top side and outer orifices, in particular holes, present therein.

The wetting radius of the adhesive on the lower outer layer is preferably 0.25-2.4 m, preferably 0.35-1.20 m.

In general, one disk is sufficient for ensuring sufficient application of adhesive. If adhesive is to be applied to a broader area, it may be advantageous to use at least two of the rotating disks described above, which can be mounted one behind the other, side by side or offset relative to one another. This prevents the adhesive from having too long a residence time on the disk and curing on the disk.

The rotational speed of the disk is preferably 200-2500 min⁻¹, particularly preferably 200-2000 min⁻¹, and in particular 300-1500 min⁻¹.

The amount of adhesive applied to the outer layer is 20-300 g/m², preferably 40-200 g/m², particularly preferably 50-120 g/m².

With the use of two-component adhesives, the adhesive is mechanically mixed before application to the rotating disk, it being possible to use high- or low-pressure mixers, preferably low-pressure mixers, and is applied to the disk by means of a suitable application apparatus, for example a downstream stirring member. If the disk is now caused to rotate by means of a drive, the adhesive is distributed extensively over the continuously transported outer layer present under the disk. For example, a static or dynamic mixer comprising plastic may be used for mixing and application of the adhesive to the disk. The amount of adhesive applied is tailored to the speed of the continuously operating unit so that the desired application amount per m² of outer layer can be realized.

The height of the disk above the layer to be wetted, the disk diameter and the rotational speed are tailored to one another so that the discharged adhesive wets the outer layer up to the edges as uniformly as possible and is usually present in the region described above.

The adhesive is spun away laterally and distributed over the outer layer present horizontally, preferably parallel to and below the rotating disk. Surprisingly, it has now been found that the application can be effected substantially without aerosols by means of the technique described above.

Aerosols are defined as colloidal systems comprising gasses, such as air, with small liquid particles of diameter about 10⁻⁷ to 10⁻³ cm finely distributed therein.

With the small applied amounts of adhesive necessary from the economic point of view, complete wetting of the lower outer layer with the adhesive can be achieved only with difficulty. Surprisingly, however, it has now been found that the coating of the lower outer layer which is achieved by means of the application technique according to the invention in the case of small applied amounts is sufficient for achieving the required tensile strength between the treated outer layer and the core layer present on top.

Surprisingly, it has furthermore been found that the pattern of application of the adhesive to the lower outer layer is more uniform if the amount of applied adhesive is in the range of 50-200 g/m². The uniformity of the pattern of application is determined by visually assessing the distribution of the adhesive over the surface of the outer layer. In a further possibility of this determination, a paper strip is placed on the unit and is weighed before and after wetting by the adhesive.

After the adhesive has been applied to the lower outer layer, the core layer is applied. The upper outer layer is applied thereto. For this purpose, this is likewise wetted with the adhesive as described above. It is then rotated and its side covered with the adhesive is placed onto the core layer.

It is also possible in principle to add adhesive to the core layer as described above and then to mount the outer layer. However, it has been found that the strength of the bond thus produced is lower than in the case of application of the adhesive to the outer layer.

Adhesives used may be the known adhesives customary for this intended use. What is decisive is that the adhesives have a viscosity such that they can be applied by means of the disk to the layers and still act as adhesives after application. It may be, for example, adhesives based on polyurethane, urea, polyvinyl acetate or hotmelts.

In a preferred embodiment of the method according to the invention, the adhesives used are those based on isocyanate. These are obtainable in general by reacting polyisocyanates with compounds having two hydrogen atoms reactive toward isocyanates, the reaction ratio preferably being chosen so that the ratio of the number of isocyanate groups to the number of groups reactive toward isocyanates in the reaction mixture is from 0.8 to 1.8:1, preferably from 1 to 1.6:1.

Polyisocyanates used are the conventional aliphatic, cycloaliphatic and in particular aromatic di- and/or polyisocyanates. Tolylene diisocyanate (TDI), diphenylmethane diisocyanate (MDI) and in particular mixtures of diphenylmethane diisocyanate and polyphenylenepolymethylene polyisocyanates (crude MDI) are preferably used.

The isocyanates from BASF AG, Lupranat® M 10, Lupranat® M 20, Lupranat® M 50, Lupranat° M 70 and Lupranat® M 200, are preferably used.

Suitable compounds having at least two hydrogen atoms reactive toward isocyanates are in general those which carry two or more reactive groups selected from OH groups, SH groups, NH groups, NH₂ groups and CH-acidic groups, such as, for example, β-diketo groups, in the molecule.

Polyetherols and/or polyesterols are preferably used, particularly preferably polyetherpolyols. The hydroxyl number of the polyetherols and/or polyesterols used is preferably from 25 to 800 mg KOH/g, and the molecular weights are in general greater than 400. The polyurethane can be prepared with or without chain extenders and/or crosslinking agents. Chain extenders and/or crosslinking agents used are in particular di- or trifunctional amines and alcohols, in particular diols and/or triols having molecular weights of less than 400, preferably from 60 to 300.

The polyol component of the adhesive preferably has a viscosity of 50-1000 mPa·s, preferably 100-800 mPa·s, particularly preferably 100-400 mPa·s (25° C.).

If appropriate, additive or reactive flameproofing agents may be present in the adhesive. Such flameproofing agents are generally used in an amount of from 0.1 to 30% by weight, based on the total amount of the polyol component.

In the reaction of the polyisocyanates with the polyols, preferably no physical blowing agents are added. Chemical blowing agents, preferably water, if appropriate as a mixture with formic acid, may be added in order to achieve a small increase in volume of the adhesive. This increase in volume serves for compensating irregularities between the contact surfaces of the outer layer and of the core layer, and for increasing the area of adhesion of the adhesive to the core layer in the case of adhesive bonding of honeycombs or other perforated, porous or net-like materials. The cured polyurethane adhesives thus have a density of from 200 to 1200 g/l, preferably from 100 to 1000 g/l, particularly preferably from 200 to 900 g/l.

In general, particleboards, MDF boards or OSB boards and plastic boards, metal plates, in particular those comprising aluminum, or a combination of the boards mentioned, are, as described, used as outer layers.

Sheet-like structures having a low weight are used core layers. These are, for example, honeycomb, folded or plug-type structures comprising paper, board, wood or light metal, in particular aluminum, or lightweight materials, such as light wood-based boards, preferably having a density of from 80 to 400 kg/m³, particularly preferably from 120 to 250 kg/m³ and in particular from 180 to 220 kg/m³.

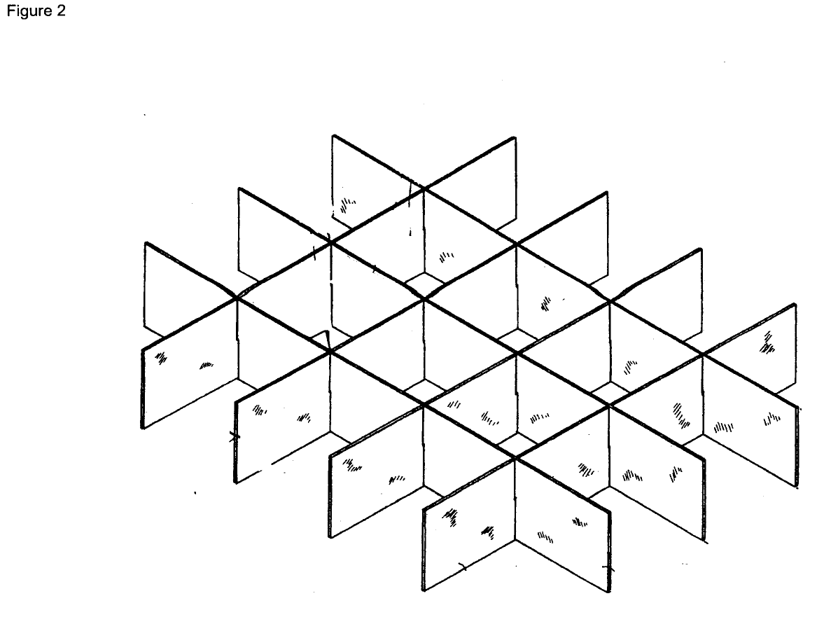

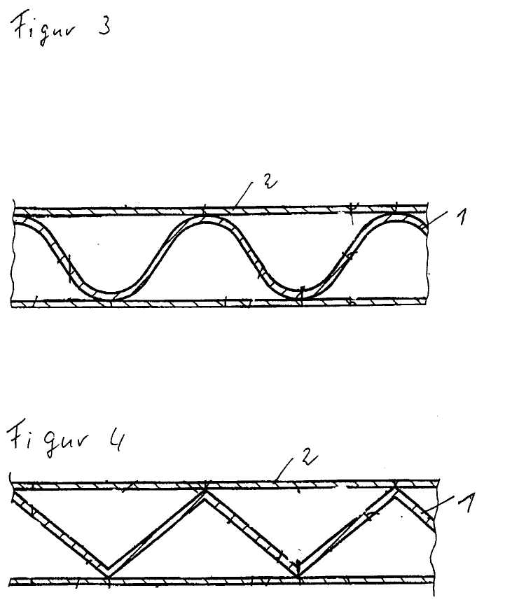

Honeycomb, folded or plug-type structures comprising paper, board, wood or light metal, in particular aluminum, are preferably used. Examples of the form of structures are hexagonal honeycombs, strip-like material having incisions, which can be inserted one into the other at right angles and can then be adhesively bonded at the contact points, as shown in FIG. 2, or strip-like material in corrugated or zigzag form (1), which can be adhesively bonded to the outer layer (2) at the points of contact, as shown in FIGS. 3 and 4.

In practice it has to date been the aim to apply a thin adhesive film which was as cohesive as possible for the production of lightweight building boards. Surprisingly, it has now been found that it is advantageous if the adhesive is present in the form of discrete points on the surface. A substantially improved adhesive strength can be achieved by the point-like adhesive bond thus obtained by application in the form of droplets.

The production of the lightweight building board can be effected, as described, discontinuously or continuously. In the discontinuous production, in each case a lower and upper outer layer cut to size are provided with the adhesive, the core layer is applied to the lower outer layer and the upper outer layer is applied thereto.

In the continuous production, lower and upper outer layers cut to size can be transported continuously and covered with adhesive by means of the apparatus used according to the invention, the core layer can be applied to the lower outer layer and the upper outer layer can be applied thereto.

It is also possible to unroll at least the lower outer layer continuously from a roll, to apply the adhesive thereto and to apply the core layer thereto. The upper outer layer can likewise be continuously removed from a roll or applied in the form of parts cut to size.

By means of the method according to the invention, lightweight building boards having a high tensile strength can be produced with economical use of adhesive. The apparatus for applying the adhesive has very good operational reliability and requires little maintenance. It can also be installed without problems in existing units for the production of lightweight building boards.

We claim:

1. A method for the production of lightweight building boards comprising at least one outer layer and a core layer adhesively bonded to this, the adhesive being applied to at least one outer layer, wherein the application of the adhesive is effected by means of one or more rotating disk(s) which is or are mounted horizontally or with a the slight deviation of up to 15° from the horizontal, preferably parallel to the outer layer.

2. The method according to claim 1, wherein the rotating flat disk is in the form of a circular flat disk.

3. The method according to claim 1, wherein the rotating flat disk is in the form of a planar disk having borders ascending in a cascade-like manner.

4. The method according to claim 1, wherein the rotating flat disk is in the form of an ellipse.

5. The method according to claim 1, wherein the rotating flat disk is in the form of a planar, at least four-pointed planar star.

6. The method according to claim 1, wherein the rotating flat disk is in the form of an at least four-pointed star with the points curved upward.

7. The method according to claim 1, wherein the rotating flat disk has four or five points in the embodiment as a star.

8. The method according to claim 1, wherein the rotating disk in the form of a planar four- or five-pointed star has no straight lines and only rounded corners.

9. The method according to claim 1, wherein the rotating disk in the form of a planar four- or five-pointed star is in the form of a four- or five-pointed star with the points curved upward.

10. The method according to claim 1, wherein the rotating disk in the form of a planar disk having borders ascending in a cascade-like manner has outlet orifices in the form of holes or slots.

11. The method according to claim 1, wherein at least two rotating disks arranged one on top of the other are used.

12. The method according to claim 1, wherein a planar disk having borders ascending in a cascade-like manner, a plurality of disks mounted one on top of the other, an ellipse or a planar four- or five-pointed star is used as the rotating disk for applying the adhesive to the lower and/or upper outer layer a) and/or the lower and/or upper side of the core layer b).

13. The method according to claim 1, wherein the adhesive used is an isocyanate-based adhesive.

14. The method according to claim 1, wherein particleboards, MDF boards, OSB boards, plastic boards or metal plates are used as outer layers.

15. The method according to claim 1, wherein honeycomb, folded or plug-type structures comprising paper, board, wood or light metal are used as core layers.

16. The method according to claim 1, wherein light wood-based boards, preferably having a density of from 80 to 400 kg/m³, are used as core layers.

17. An apparatus for the production of lightweight building boards by adhesive bonding of at least one outer layer to a core layer, wherein, for the application of the adhesive to the outer layer, said apparatus comprises one or more rotating disk(s) which are mounted one on top of the other and horizontally or with a slight deviation of up to 150 from the horizontal, preferably parallel to the outer layer.
